(19) United States
(12) Patent Application Publication
(10) Pub. No.: US 2025/0016870 A1
(43) Pub. Date: Jan. 9, 2025

(54) METHOD AND APPARATUS FOR PROVIDING SERVICE FUNCTION CHAIN IN WIRELESS COMMUNICATION SYSTEM

(71) Applicant: Samsung Electronics Co., Ltd., Gyeonggi-do (KR)

(72) Inventors: Jungshin PARK, Gyeonggi-do (KR); Sangsoo JEONG, Gyeonggi-do (KR)

(21) Appl. No.: 18/721,017

(22) PCT Filed: Nov. 21, 2022
(86) PCT No.: PCT/KR2022/018437

§ 371 Date: Jun. 17, 2024

(30) Foreign Application Priority Data
Nov. 19, 2021 (KR) 10-2021-0160120

(51) Int. Cl. H04W 76/20; H04L 41/0894; H04W 80/06

(52) U.S. Cl. CPC H04W 76/20; H04L 41/0894; H04W 80/06

(57) ABSTRACT

The present disclosure relates to a 5G or 6G communication system for supporting a higher data transmission rate. One embodiment of the present invention can provide a method and an apparatus for providing a network service function requested by an application server in a wireless communication system.

### TECHNICAL FIELD

The disclosure relates to a wireless communication system and, more particularly, to a method and an apparatus for providing a network service function requested by an application server in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave such as 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

In the initial stage of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication. Furthermore, such development of 5G mobile communication systems will serve as a basis for developing not only new waveforms for securing coverage in terahertz bands of 6G mobile communication technologies. Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

In order to provide functions for processing user packets provided by a user plane function of a wireless communication system so as to allow an application server to use the functions, a method and an apparatus through which the application server transfers required requests to the wireless communication system and manages the same in the network are needed. When the method is not provided, the application server should implement the packet processing function provided by the wireless communication system by itself, and thus complexity and costs may increase.

An embodiment of the disclosure is to provide a method and an apparatus through which the application server transfers required requests to the wireless communication system and manages the same in the network.

The technical subjects pursued in the disclosure may not be limited to the above-mentioned technical subjects, and other technical subjects which are not mentioned may be clearly understood from the following descriptions by those skilled in the art to which the disclosure pertains.

### Solution to Problem

An embodiment of the disclosure to solve the problems is to provide a method of dynamically configuring and managing required user plane functions according to a request from an application server.

A method performed by a service function chaining supporting function (SFCSF) of a communication system according to an embodiment of the disclosure to solve the problems includes receiving, from an application function (AF) or a policy control function (PCF), information associated with service function chaining (SFC) including information on an application to which the SFC is applied and information on a user equipment (UE) to which the SFC is applied, receiving, from a session management function (SMF), a request message making a request for SFC information related to a packet processing method to be applied to a PDU session according to a protocol data unit (PDU) session configuration or modification (change) request of the UE, and transmitting, to the SMF, a response message including the SFC information related to the packet processing method to be applied to the PDU session, determined based on the information related to the SFC.

The information related to the SFC may include at least one of information on traffic of the application to which the SFC is applied, traffic filter information, pattern information, source and destination Internet protocol (IP) addresses, transmission control protocol (TCP) port information, user datagram protocol (UDP) port information, a list of UEs to which the SFC is applied, an identifier of the application to which the SFC is applied, or information indicating a series of service functions to be requested.

The SFC information related to the packet processing method to be applied to the PDU session may include at least one of the information on traffic of the application to which the SFC is applied, the source and destination IP addresses, the TCP port information, the UDP port information, the list of UEs to which the SFC is applied, area or time information to which the SFC is applied, or a list of user plane functions to which the SFC is applied.

The request message may include at least one of the identifier of the application, the source and destination IP addresses, the TCP port information, the UDP port information, an identifier of a slice designated to the application, a data network name (DNN), subscription information of the UE, location information of the UE, or time information of the UE.

The method may further include identifying, with the PCF, whether the SFC according to the information related to the SFC is a service function allowed for UEs to which the SFC is applied.

The SFCSF may include at least one of the SMF, the PCF, or a network exposure function (NEF).

A method performed by a session management function (SMF) of a communication system according to an embodiment of the disclosure to solve the problems includes receiving, from a user equipment (UE), a protocol data unit (PDU) session configuration or modification (change) request message, transmitting, to a service function chaining supporting function (SFCSF), a request message making a request for service function chaining (SFC) information associated with a packet processing method to be applied to a PDU session, receiving, from the SFCSF, a response message including the SFC information associated with the packet processing method to be applied to the PDU session according to the request message, identifying at least one user plane function (UPF) to which a function of a service related to the PDU session is provided based on the SFC information, transmitting, to the at least one UPF, a path configuration or change (modification) message including the information on the packet processing method to be applied to a packet of the PDU session identified based on the SFC information, and transmitting, to the UE, a message including information on a PDU session configuration or modification (change) result.

The information related to the packet processing method may include at least one of information on traffic of the application to which the SFC is applied, source and destination Internet protocol (IP) addresses, transmission control protocol (TCP) port information, user datagram protocol (UDP) port information, a list of UEs to which the SFC is applied, a service function to be processed by each UPF, or information on a next UPF to transmit a result processed by each UPF.

A service function chaining supporting function (SFCSF) of a communication system according to an embodiment of the disclosure to solve the problems includes a transceiver and a controller connected to the transceiver and configured to receive, from an application function (AF) or a policy control function (PCF), information associated with service function chaining (SFC) including information on an application to which the SFC is applied and information on a user equipment (UE) to which the SFC is applied, receive, from a session management function (SMF), a request message making a request for SFC information related to a packet processing method to be applied to a PDU session according to a PDU session configuration or modification (change) request of the UE, and transmit, to the SMF, a response message including the SFC information related to the packet processing method to be applied to the PDU session, determined based on the information related to the SFC.

A session management function (SMF) of a communication system according to an embodiment of the disclosure to solve the problems includes a transceiver and a controller connected to the transceiver and configured to receive, from a user equipment (UE), a protocol data unit (PDU) session configuration or modification (change) request message, transmit, to a service function chaining supporting function (SFCSF), a request message making a request for service function chaining (SFC) information associated with a packet processing method to be applied to a PDU session, receive, from the SFCSF, a response message including the SFC information associated with the packet processing method to be applied to the PDU session according to the request message, identify at least one user plane function (UPF) to which a function of a service related to the PDU session is provided based on the SFC information, transmit, to the at least one UPF, a path configuration or change (modification) message including the information on the packet processing method to be applied to a packet of the PDU session identified based on the SFC information, and transmit, to the UE, a message including information on a PDU session configuration or modification (change) result.

### Advantageous Effects of Invention

An embodiment of the disclosure may provide a method and an apparatus through which an application server transfers needed requirements to a wireless communication system and manages the same in the network.

Advantageous effects obtainable from the disclosure may not be limited to the above-mentioned effects, and other effects which are not mentioned may be clearly understood, through the following descriptions, by those skilled in the art to which the disclosure pertains.

### BRIEF DESCRIPTION OF DRAWINGS

FIG. 1 illustrates a system structure of a 5GS according to an embodiment of the disclosure.

FIG. 2 illustrates a configuration of a system device according to an embodiment of the disclosure.

FIG. 3 illustrates a service function chaining configuration procedure according to an embodiment of the disclosure.

FIG. 4 illustrates a configuration of the UE according to an embodiment of the disclosure.

FIG. 5 illustrates a configuration of a network entity according to an embodiment of the disclosure.

### MODE FOR THE INVENTION

Hereinafter, embodiments of the disclosure will be described in detail in conjunction with the accompanying drawings. In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Hereinafter, the disclosure relates to a method and an apparatus for providing various services in a wireless communication system. Specifically, the disclosure describes a technology for reducing development and operation costs of applications and improving the performance by allowing an application server to use a high-performance packet processing function in response to a request for the high-performance packet processing function provided by a user plane function of a wireless communication system from the application server in the wireless communication system.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, terms and names defined in the 3rd generation partnership project long term evolution (3GPP LTE) and 5G standards are used for the sake of descriptive convenience. However, the disclosure is not limited by these terms and names, and may be applied in the same way to systems that conform other standards.

For convenience of the following description, names of NFs (for example, access and mobility management function (AMF), session management function (SMF), and network slice selection function (NSSF)) may be used for targets that exchange information for access control and state management. However, embodiments of the disclosure may be equally applied to the case in which the NF is actually implemented as instance (AMF Instance, SMF Instance, or NSSF Instance).

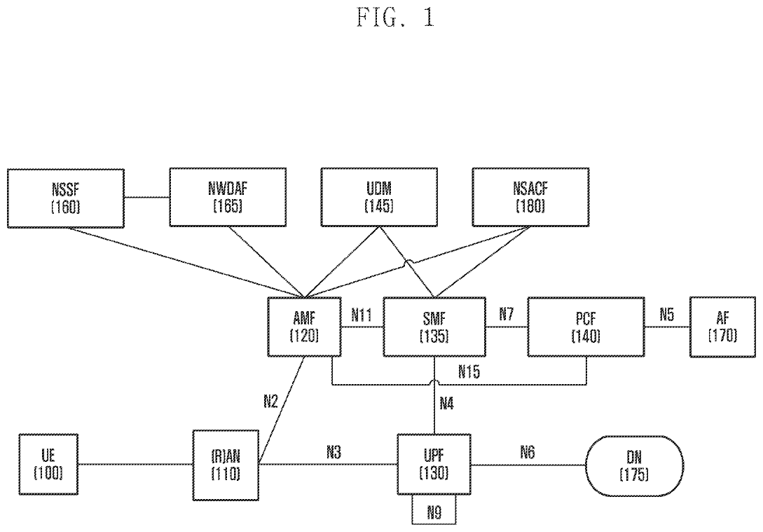

FIG. 1 illustrates a system structure of a 5G system (5GS) according to an embodiment of the disclosure.

Referring to FIG. 1, the 5GS may include a 5G core network, a base station, and a user equipment (UE). A 5G core network (or 5G core network) may include an AMF 120, an SMF 135, a user plane function (UPF) 130, a policy control function (PCF) 140, a unified data management (UDM) 145, an NSSF 160, a network data analytics function (NWDAF) 165, and a non-3GPP function (N3F) (not shown).

The UE 100 may access to the 5G core network through a radio access network ((R)AN) base station (or base station) 110. The (R)AN 110 may support types of 3GPP access networks (for example, new radio (NR), evolved universal terrestrial radio access (E-UTRA), and the like) or non-5GPP access networks (for example, Wi-Fi and the like). Via the (R)AN 110, the UE 100 may be connected to the AMF 120 through an N2 interface and connected to the UPF 130 through an N3 interface. The (R)AN 110 may be referred to as an “access point (AP)”, an “evolved NodeB (eNB)”, a “5^{th}-generation (5G) node”, a “gNodeB (gNB)”, or another term having a technical meaning equivalent thereto, as well as a “base station”. An N3F is an NF that operates as termination of the N2 interface and the N3 interface for the UE 100 accessing through access networks (non-3GP access network) (for example. Wi-Fi and the like) that are not defined in the 3GPP. The N3F may process N2 control plane signaling and N3 user plane packets.

The AMF 120 is an NF that manages radio access and mobility of the user equipment (UE or terminal) 100. The SMF 135 is an NF that manages a session of the UE 100, and session information includes quality of service (QoS) information, charging information, and information on packet processing. The UPF 130 is an NF that processes user traffic (user plane traffic) and is controlled by the SMF 135. The PCF 140 is an NF that manages an operator policy for providing a service in a wireless communication system. The UDM 145 is an NF that stores and manages subscription information of the UE 100 (UE subscription). Unified data repository (UDR) (not shown) is an NF that stores and manages data. The UDR may store UE subscription information and provide the UE subscription information to the UDM 145. Further, the UDR may store operator policy information and provide the operator policy information to the PCF 140. The NWDAF 165 is an NF that provides analysis information for the operation of the 5G system. The NWDAF 165 may collect data from other NFs or operations, administration, and maintenance (OAM) (not shown) included in the 5G system, analyze the collected data, and provide the analysis result to other NFs. The NSACF 180 is an NF that monitors and controls the number of registered UEs and the number of sessions of the network slice which is a target of network slice admission control (NSAC). The NSACF 180 stores configuration information about the maximum number of registered UEs and the maximum number of sessions for each network slice.

Hereinafter, for convenience of description, targets that exchange information for access control and state management are collectively referred to as NFs. However, embodiments of the disclosure may be equally applied to the case in which the NF is actually implemented as instance (AMF Instance, SMF Instance, or NSSF Instance).

In the disclosure, an instance may mean a state in which a specific NF exists in the form of a software code and physical or/and logical resources may be allocated from a computing system to perform an NF function and executed by a physical computing system, for example, a specific computing system existing in a core network. Accordingly, an AMF instance, an SMF instance, or the NSSF instance may mean that physical or/and logical resources can be used for the operation of the AMF 120, the SMF 135, or the NSSF 160 after being allocated from a specific computing system existing in a core network. As a result, the AMF instance, the SMF instance, and the NSSF instance receiving allocation of physical or/and logical resources for the operation of the AMF 120, the SMF 135, and the NSSF 160 from a specific computing system existing in the network may perform the same operation as that in the case in which the physical AMF 120, SMF 135, and NSSF 160 exist. Accordingly, in embodiments of the disclosure, the description of the NFs (AMF 120, SMF 135, UPF 130, NSSF 160, NR repository function (NRF), or service communication prow (SCP)) may be replaced with NF instances or inversely the description of the NF instances may be replaced with the NFs. Similarly, in embodiments of the disclosure, the description of the network slice may be replaced with the network slice instance or inversely the description of the network slice instance may be replaced with the network slice.

According to an embodiment of the disclosure, in the 5G system defined in the 3GPP, one network slice may be referred to as single-network slice selection assistance information (S-NSSAI). The S-NSSAI may include a slice/service type (SST) value and a slice differentiator (SD) value. The SST may indicate a characteristic of the service supported by the slice (for example, eMBB, IoT, URLLC. V2X, or the like). The SD may be a value used as an additional identifier for a specific service referred to as the SST.

The NSSAI may include one or more S-NSSAIs. Examples of the NSSAI may include configured NSSAI stored in the UE 100, requested NSSAI for which the UE 100 makes a request, allowed NSSAI allowed to be used by the UE 100 that is determined by the NF of the 5G core network (for example, the AMF 120, the NSSF 160, or the like), and subscribed NSSAI to which the UE 100 subscribes, but the disclosure is not limited thereto.

The UE 100 may be simultaneously connected to the access network 110 and registered in the 5G system. Specifically, the UE 100 may access the (R)AN 110 to perform a UE registration procedure with the AMF 120. During the registration procedure, the AMF 120 may determine an allowed slice (allowed NSSAI) which can be used by the UE 100 accessing the (R)AN 110 and allocate the allowed NSSAI to the UE 100. The UE 100 may select a specific slice and configure a PDU session for communication with an actual application server. One PDU session may include one or a plurality of QoS flows, and respective QoS flows may configure different parameters of QoS and provide different transmission performance required for respective application services.

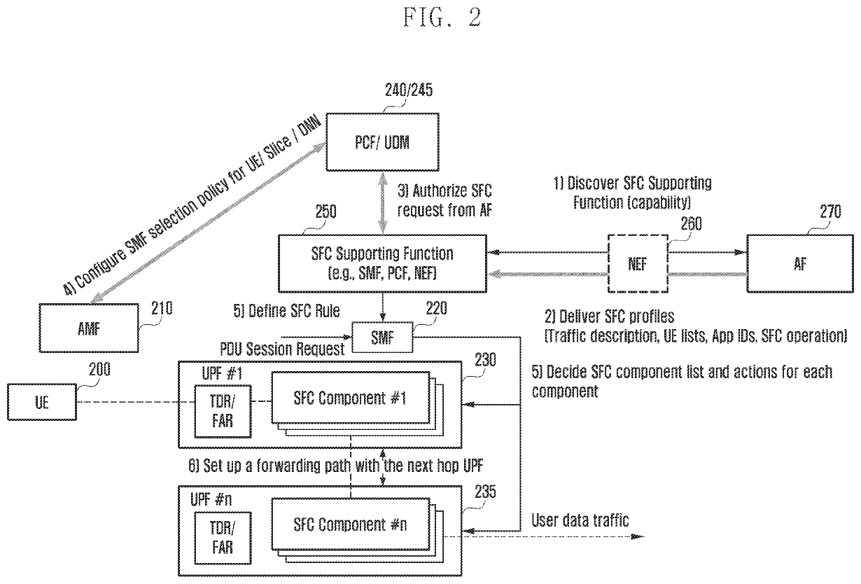

FIG. 2 illustrates a configuration of a device for configuring and managing service function chaining in a wireless communication system according to an embodiment of the disclosure. Referring to FIG. 2, an application server 270 (illustrated as an application function (AF) in an embodiment, but a separate server may make a request for the corresponding operation through the AF of the wireless communication system) according to an embodiment of the disclosure may make a request for processing desired specific packets of the UE 200 through a method designated by the application using a packet processing function provided by a user plane function of the wireless communication system and transferring the packets to the application or the UE 200.

The device for managing the service function chaining illustrated in FIG. 2 may include the UE 200, an AMF 220, an SMF 220, UPFs 230 and 235, an AF 270, a network exposure function (NEF) 260, a PCF 240, and a UDM 245 which are predefined 5G network functions (NFs), and a service function chaining supporting function (SFCSF) 250 newly introduced in the disclosure. The SFCSF 250 may be a new separate entity or may be a function included in a predefined entity such as the SMF 220, the PCF 240, or the NEF 260 according to an embodiment. For example, at least some of the operations performed by the SFCSF 250 may be performed by at least one of the SMF 220, the PCF 240, and the NEF 260.

In this case, the AF 270 may transfer a service function chaining (SFC) profile that describes service function chaining requirements transmitted by the application server to the SFCSF 260 (or the PCF 240 according to implementation) through the NEF 260 or directly discover an appropriate SFCSF 250 and transmit the same. Before transmitting the profile, the AF 270 may perform a procedure of making a request for information to the SFCSF 250 or the NRF (not shown) through the NEF 260 in order to acquire the information on the type of packet processing service provided by the user plane function of the wireless communication system. The service function chaining profile may include information on traffic description that designates traffic information to which service function chaining (including information on a traffic filter for detecting corresponding application traffic, a pattern, source and destination IP addresses, a TCP port, and a UDP port) is applied, a list of UEs to which the service function chaining is applied, an identifier of a target application, and SFC application(s) that designate a series of service functions to be requested.

The SFCSF 250 (or the PCF 240 according to implementation) receiving the service function chaining profile from the AF 270 may perform a process of identifying whether a series of service functions (SFC operations(s)) requested by the AF 270 included in the profile are services allowed for the AF 270 with respect to the designated UE 200 and application through the PCF 240 or the UDM 245. When it is identified that the requested SFC operation(s) are allowed, the SFCSF 250 may store service function chaining profile information.

Meanwhile, in order to provide a series of service functions for which the AF 270 made the request, the PCF 240 may perform a procedure of determining a slice and a data network name (DNN) to be applied to the corresponding service of the UE 200, configuring a selection policy of the SMF 220 to manage a session corresponding to the determined slice and DNN, and transferring the selection policy to the AMF 210.

In the following process, when the UE 200 makes a request for generating a protocol data unit (PDU) session or QoS flow to transmit data of the designated application, the AMF 210 may select the appropriate SMF 220 through the application of the SMF selection policy configured by the PCF 240 and transmit a PDU session configuration request of the UE 200. When receiving the PDU session configuration request of the UE 200, the SMF 220 may make a request for a session management policy to be applied to the session from the PCF 240 and identify whether service function chaining included in the received policy is applied. When the policy is configured to apply the service function chaining to the session of the UE 200 or the QoS flow, the SMF 220 may make a request for an SFC rule to be applied to the corresponding session or QoS flow to the SFCSF 250. The SFC rule may include a traffic descriptor that designates traffic to which the service function chaining (for example, source and destination IP addresses, a TCP/UDP port number, an application identifier, or the like) is applied, a UE identifier list, area and time information to apply the service function chaining, and a user plane function list to be applied.

The SMF 220 may identify a required user plane function list from the SFC rule information received from the SFCSF 250 and determine a UPF list to provide each function included in the function list. The SMF 220 may perform a path configuration procedure with the UPF 230 or 235 to perform each function. The SMF 220 may transfer a path configuration message including information for designating a service function to be performed by each UPF 230 or 235 and the next UPF to which the processed result is transmitted to the UPF 230 or 235.

As a result, the first UPF 230 may apply the traffic descriptor specified in the SFC rule (for example, the source and destination IP addresses, the TCP/UDP port number, the application identifier, and the like) and UE identifier list information to the packet received from the UE 200 to select a packet to which the service function chaining is applied, apply the first service function in the service function chaining designated by the SMF 220 to process the packet, and then transmit the processed packet to the designated second UPF 235. Through the above method, packets processed by all of the designated UPFs 230 and 235 through the application of the designated service functions may be transmitted to the outside of the wireless communication network via the last UPF 235 to be finally transferred to the packet destination address.

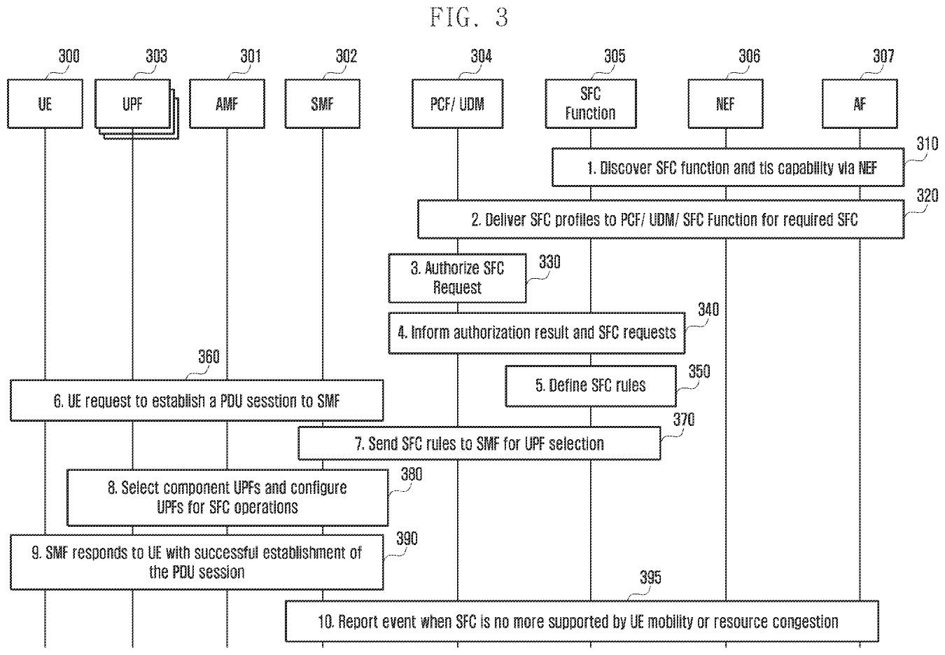

FIG. 3 illustrates a service function chaining configuration procedure according to an embodiment of the disclosure. Hereinafter, an operation procedure of a method proposed in the disclosure is described with reference to FIG. 3.

In operation 310, an AF 307 may ask the NRF (not shown) about SFCSF information directly or via an NEF 306 and receive an address of each SFCSF 305 and supported service function chaining information provided in the wireless communication system. In the case of a system in which no NRE is installed, the AF 307 may directly receive service function chaining information supported for each SFCSF from the SFCSF 305 with reference to the SFCSF address configured within the AF 307.

In operation 320, the AF 307 may select an appropriate SFCSF 305 with reference to the service function chaining information received from the SFCSF 305, select an application to which the service function chaining is applied, determine target UEs, and then transmit information thereon to a PCF 304 (or a UDM according to an implementation method) of the wireless communication system in the form of an SFC profile. Alternatively, when the AF 307 is configured to directly transmit the SFC profile to the SFCSF 305 by the wireless communication system, the AF 307 may directly transmit the SFC profile to the SFCSF 305. At this time, the AF 307 may transmit the information to the PCF 304 or the SFCSF 305 directly or via the NEF 306 according to the trust relationship with the network in order to transmit the SFC profile. The SFC profile may include information on at least one of traffic description that designates traffic information to which service function chaining (including information on a traffic filter for detecting corresponding application traffic, a pattern, source and destination IP addresses, a TCP port, and a UDP port) is applied, a list of UEs to which the service function chaining is applied, an identifier of a target application, and SFC application(s) that designate a series of service functions to be requested.

In operation 330, the PCF 304 (or the UDM) receiving the SFC profile from the AF 307 may identify whether the service functions (SFC operation(s)) included in the SFC profile requested by the AF 307 are service functions allowed for UEs 300 designated in the profile and return a response message including whether the SFC operations(s) are allowed or only allowed service function to the AF 307 in response to the request.

In operation 340, the PCF 304 may transmit service function chaining information included in the allowed SFC profile in operation 330 to the SFCSF 305 and make a request for generating an SFC rule to apply the service function chaining requested by the AF 307 to packets during a packet transmission process related to the case where a session for the predetermined application is configured for the UEs 300 designated by the AF 307. The request message which the PCF 304 transmits to the SFCSF 305 may include at least one of information included in the SFC profile received from the AF 307, the session management policy, and UE subscription information.

In operation 350, the SFCSF 305 may determine and store the SFC rule to be applied to the UEs 300 requested based on the information received from the PCF 304 during the process of operation 340. The SFC rule may include at least one of a traffic descriptor that designates traffic to which the service function chaining (for example, source and destination IP addresses, a TCP/UDP port number, an application identifier, or the like) is applied, a UE identifier list, area and time information to which the service function chaining is applied, and a user plane function list to be applied.

In operation 360, the UE 300 may initiate a procedure of configuring a new session (or changing a session for adding new QoS flow to the existing session) in the wireless communication system for communication with the application server. The case illustrated in FIG. 3 corresponds to the case where a new session is generated, but the case where a session is changed (modified) to add the QoS flow may be implemented through a similar process. A session configuration request message of the UE 300 may include information on at least one of an application identifier, source and destination IP addresses, TCP/UDP port information, slice identifier designated to the application, and a DNN.

In operation 370, the SMF 302 receiving the request of the UE 300 may transfer information which the UE 30) inserted into the request message to the PCF 304 and make a request for a policy to be applied to the session. The PCF 304 may determine a session management policy to be applied to the session of the corresponding UE 300 and transfer the session management policy to the SMF 302. The session management policy may include information indicating whether a service function chaining configuration is needed for the generated session or QoS flow. When the service function chaining configuration is needed from the session management policy received from the PCF 304, the SMF 302 may make a request for the SFC rule to be applied to the session to the SFCSF 305 to receive the same. The request message of the SMF 302 may include at least one of an application identifier, source and destination IP addresses, TCP/UDP port information, a slice identifier designated to the application, a DNN, subscription information of the UE 300, and location and time information of the UE 300. During the process, the SFCSF 305 may select the SFC rule that matches the information included in the request message received from the SMF 302 and is stored in operation 350 and transmit the SFC rule to the SMF 302 (according to implementation, the PCF 304 may receive the SFC rule from the SFCSF 305 instead of the SMF 305, insert the SFC rule into the session management policy, and transmit the session management policy to the SMF 302).

In operation 380, the SMF 302 may identify required service functions (SFC operation(s)) from the SFC rule received from the SFCSF 305. The SMF 302 may determine UPFs 303 to provide respective functions and transmit a message making a request for configuring a path for the session to each UPF 303. The SMF 302 may transmit a path configuration message including SFC traffic descriptor(s) that designates a packet of the UE 300 to which the service function chaining is applied and information that designates the next UPF to which the service function to be processed by each UPF 303 and the processed result are transmitted (UPF ID or tunnel address allocated by the UPF) to the UPF 303. As a result, the first UPF 303 may apply the traffic descriptor specified in the SFC rule (for example, the source and destination IP addresses, the TCP/UDP port number, the application identifier, and the like), UE identifier list information, the DNN, and the slice identifier to the packet received from the UE to select a packet to which the service function chaining is applied, apply the first service function designated by the SMF 302 to process the packet, and then transmit the processed packet to the designated second UPF. Through the above method, packets processed by all of the designated UPFs 303 through the application of the service function which the SMF 302 designated to each UPF 303 may be transmitted to the outside of the wireless communication network via the last UPF 303 to be finally transferred to the packet destination address.

In operation 390, the SMF 302 that has completed the configuration with each UPF 303 to configure the service function chaining to be applied to the session (or QoS flow) requested by the UE 300 may transmit a response message indicating that the PDU session (or QoS flow) configuration requested by the UE 300 has been successfully completed to the UE 300.

In operation 395, when the corresponding session (or QoS flow) is released by the UE 300 or the network or is not used any more due to movement of the UE 300 or network congestion, the SMF 302 may notify the PCF 304 and the SFCSF 305 of this. In this case, the PCF 304 or the SFCSF 305 may notify the AF 307 that made the request for the service function chaining that the service function chaining requested by the AF 307 is not applied any more to traffic of the predetermined application of the UE 300.

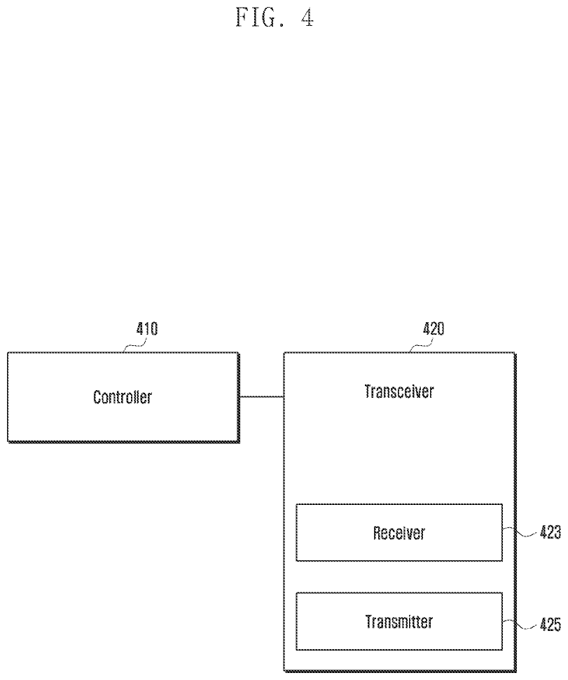

FIG. 4 illustrates a configuration of the UE according to an embodiment of the disclosure. Referring to FIG. 4, the UE according to an embodiment of the disclosure may include a transceiver 420 and a controller 410 configured to control the overall operation of the UE. The transceiver 420 may include a transmitter 425 and a receiver 423.

The transceiver 420 may transmit and receive signals to and from other network entities. The controller 410 may control the UE to perform one operation in the above-described embodiments. Meanwhile, the controller 410 and the transceiver 420 do not have to be implemented as separated modules but may be implemented as one element such as a single chip. The controller 410 and the transceiver 420 may be electrically connected. For example, the controller 410 may be a circuit, an application-specific circuit, or at least one processor. The operations of the UE may be implemented as a memory device storing the corresponding program code is included in a predetermined element within the UE.

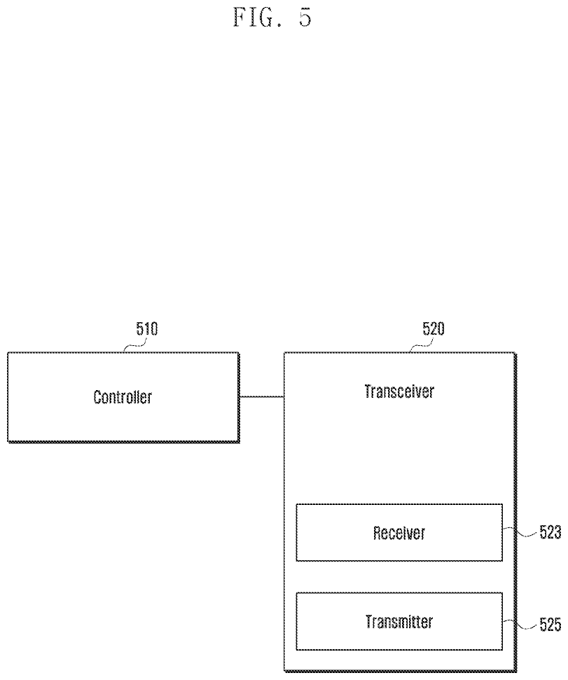

FIG. 5 illustrates a configuration of a network entity according to an embodiment of the disclosure.

The network entity according to the disclosure is a concept including a network function according to system implementation.

Referring to FIG. 5, the network entity according to an embodiment of the disclosure may include a transceiver 520 and a controller 510 configured to control the overall operation of the network entity. The transceiver 520 may include a transmitter 525 and a receiver 523. The transceiver 520 may transmit and receive signals to and from other network entities.

The controller 510 may control the network entity to perform one operation in the above-described embodiments. Meanwhile, the controller 510 and the transceiver 520 do not have be implemented as separated modules but may be implemented as one element such as a single chip. The controller 510 and the transceiver 520 may be electrically connected. For example, the controller 510 may be a circuit, an application-specific circuit, or at least one processor. Further, the operations of the network entity may be performed by including a memory device storing a corresponding program code in a predetermined element within the network entity.

The network entity may be one of a base station (RAN), an AMF, an SMF, a UPF, a PCF, an SFCSF, an NRF, an NEF, an AF, an NSSF, an NSACF, a UDM, and a UDR.

It should be noted that the configuration diagrams, illustrative diagrams of control/data signal transmission methods, illustrative diagrams of operation procedures, and structural diagrams as illustrated in FIG. 1 to FIG. 5 are not intended to limit the scope of protection of the disclosure. That is, all the constituent units, entities, or operation steps shown in FIG. 1 to FIG. 5 should not be construed as essential elements for implementing the disclosure, and even when including only some of the elements, the disclosure may be implemented without impairing the true nature of the disclosure.

The above-described operations of a base station or a terminal may be implemented by providing a memory device storing corresponding program codes in a bast station or terminal device. That is, a controller of the base station or terminal device may perform the above-described operations by reading and executing the program codes stored in the memory device by means of a processor or central processing unit (CPU).

Various units or modules of a network entity, a base station device, or a terminal device may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method performed by a service function chaining supporting function (SFCSF) in a communication system, the method comprising:
receiving, from an application function (AF) or a policy control function (PCF), information associated with service function chaining (SFC) comprising information on an application to which the SFC is applied and information on a user equipment (UE) to which the SFC is applied;
receiving, from a session management function (SMF), a request message making a request for SFC information related to a packet processing method to be applied to a protocol data unit (PDU) session according to a PDU session configuration or modification request of the UE; and
transmitting, to the SMF, a response message comprising the SFC information related to the packet processing method to be applied to the PDU session, determined based on the information related to the SFC.

2. The method of claim 1,
wherein the information related to the SFC comprises at least one of information on traffic of the application to which the SFC is applied, traffic filter information, pattern information, source and destination Internet protocol (IP) addresses, transmission control protocol (TCP) port information, user datagram protocol (UDP) port information, a list of UEs to which the SFC is applied, an identifier of the application to which the SFC is applied, or information indicating a series of service functions to be requested,
wherein the SFC information related to the packet processing method to be applied to the PDU session comprises at least one of the information on traffic of the application to which the SFC is applied, the source and destination IP addresses, the TCP port information, the UDP port information, the list of UEs to which the SFC is applied, area or time information to which the SFC is applied, or a list of user plane functions to which the SFC is applied, and
wherein the request message comprises at least one of the identifier of the application, the source and destination IP addresses, the TCP port information, the UDP port information, an identifier of a slice designated to the application, a data network name (DNN), subscription information of the UE, location information of the UE, or time information of the UE.

3. The method of claim 1, further comprising:
identifying, with the PCF, whether the SFC according to the information related to the SFC is a service function allowed for UEs to which the SFC is applied.

4. The method of claim 1,
wherein the SFCSF comprises at least one of the SMF, the PCF, or a network exposure function (NEF).

5. A method performed by a session management function (SMF) of a communication system, the method comprising:
receiving, from a user equipment (UE), a protocol data unit (PDU) session configuration or modification request message;
transmitting, to a service function chaining supporting function (SFCSF), a request message making a request for service function chaining (SFC) information associated with a packet processing method to be applied to a PDU session;
receiving, from the SFCSF, a response message comprising the SFC information associated with the packet processing method to be applied to the PDU session according to the request message;
identifying at least one user plane function (UPF) to which a function of a service related to the PDU session is provided based on the SFC information;
transmitting, to the at least one UPF, a path configuration or change message comprising the information on the packet processing method to be applied to a packet of the PDU session identified based on the SFC information; and
transmitting, to the UE, a message comprising information on a PDU session configuration or modification result.

6. The method of claim 5,
wherein the information on the SFC related to the packet processing method to be applied to the PDU session comprises at least one of information on traffic of the application to which the SFC is applied, source and destination Internet protocol (IP) addresses, transmission control protocol (TCP) port information, user datagram protocol (UDP) port information, a list of UEs to which the SFC is applied, area or time information to which the SFC is applied, or a list of user plane functions to which the SFC is applied, and
wherein the request message comprises at least one of an identifier of the application, the source and destination IP addresses, the TCP port information, the UDP port information, an identifier of a slice designated to the application, a data network name (DNN), subscription information of the UE, location information of the UE, or time information of the UE.

7. The method of claim 5,
wherein the information on the packet processing method comprises at least one of information on traffic of the application to which the SFC is applied, source and destination Internet protocol (IP) addresses, transmission control protocol (TCP) port information, user datagram protocol (UDP) port information, a list of UEs to which the SFC is applied, a service function to be processed by each UPF, or information on a next UPF to transmit a result processed by each UPF.

8. The method of claim 5,
wherein the SFCSF comprises at least one of the SMF, the PCF, or a network exposure function (NEF).

9. A service function chaining supporting function (SFCSF) of a communication system, the SFCSF comprising:
a transceiver; and
a controller connected to the transceiver and configured to receive, from an application function (AF) or a policy control function (PCF), information associated with service function chaining (SFC) comprising information on an application to which the SFC is applied and information on a user equipment (UE) to which the SFC is applied, receive, from a session management function (SMF), a request message making a request for SFC information related to a packet processing method to be applied to a protocol data unit (PDU) session according to a PDU session configuration or modification request of the UE, and transmit, to the SMF, a response message comprising the SFC information related to the packet processing method to be applied to the PDU session, determined based on the information related to the SFC.

10. The SFCSF of claim 9,
wherein the information related to the SFC comprises at least one of information on traffic of the application to which the SFC is applied, traffic filter information, pattern information, source and destination Internet protocol (IP) addresses, transmission control protocol (TCP) port information, user datagram protocol (UDP) port information, a list of UEs to which the SFC is applied, an identifier of the application to which the SFC is applied, or information indicating a series of service functions to be requested,
wherein the SFC information related to the packet processing method to be applied to the PDU session comprises at least one of the information on traffic of the application to which the SFC is applied, the source and destination IP addresses, the TCP port information, the UDP port information, the list of UEs to which the SFC is applied, area or time information to which the SFC is applied, or a list of user plane functions to which the SFC is applied, and
wherein the request message comprises at least one of the identifier of the application, the source and destination IP addresses, the TCP port information, the UDP port information, an identifier of a slice designated to the application, a data network name (DNN), subscription information of the UE, location information of the UE, or time information of the UE.

11. The SFCSF of claim 9,
wherein the controller is configured to identify, with the PCF, whether the SFC according to the information related to the SFC is a service function allowed for UEs to which the SFC is applied, and
wherein the SFCSF comprises at least one of the SMF, the PCF, or a network exposure function (NEF).

12. A session management function (SMF) of a communication system, the SMF comprising:
a transceiver; and
a controller connected to the transceiver and configured to receive, from a user equipment (UE), a protocol data unit (PDU) session configuration or modification request message, transmit, to a service function chaining supporting function (SFCSF), a request message making a request for service function chaining (SFC) information associated with a packet processing method to be applied to a PDU session, receive, from the SFCSF, a response message comprising the SFC information associated with the packet processing method to be applied to the PDU session according to the request message, identify at least one user plane function (UPF) to which a function of a service related to the PDU session is provided based on the SFC information, transmit, to the at least one UPF, a path configuration or change message comprising the information on the packet processing method to be applied to a packet of the PDU session identified based on the SFC information, and transmit, to the UE, a message comprising information on a PDU session configuration or modification result.

13. The SMF of claim 12,
wherein the SFC information related to the packet processing method to be applied to the PDU session comprises at least one of information on traffic of the application to which the SFC is applied, source and destination Internet protocol (IP) addresses, transmission control protocol (TCP) port information, user datagram protocol (UDP) port information, a list of UEs to which the SFC is applied, area or time information to which the SFC is applied, or a list of user plane functions to which the SFC is applied, and
wherein the request message comprises at least one of an identifier of the application, the source and destination IP addresses, the TCP port information, the UDP port information, an identifier of a slice designated to the application, a data network name (DNN), subscription information of the UE, location information of the UE, or time information of the UE.

14. The SMF of claim 12,
wherein the information on the packet processing method comprises at least one of information on traffic of the application to which the SFC is applied, source and destination Internet protocol (IP) addresses, transmission control protocol (TCP) port information, user datagram protocol (UDP) port information, a list of UEs to which the SFC is applied, a service function to be processed by each UPF, or information on a next UPF to transmit a result processed by each UPF.

15. The SMF of claim 12,
wherein the SFCSF comprises at least one of the SMF, the PCF, or a network exposure function (NEF).
